(19) United States
(12) Patent Application Publication
(10) Pub. No.: US 2019/0235231 A1
(43) Pub. Date: Aug. 1, 2019

(54) OPTICAL FIBER SCANNER, ILLUMINATION DEVICE, AND OBSERVATION DEVICE

(71) Applicant: OLYMPUS CORPORATION, Tokyo (JP)

(72) Inventors: Takashi YASUMI, Tokyo (JP); Yasuaki KASAI, Saitama (JP); Hiroshi TSURUTA, Kanagawa (JP); Hirokazu YOKOTA, Tokyo (JP)

(73) Assignee: OLYMPUS CORPORATION, Tokyo (JP)

(21) Appl. No.: 16/382,325

(22) Filed: Apr. 12, 2019

Related U.S. Application Data
(63) Continuation of application No. PCT/JP2016/081176, filed on Oct. 20, 2016.

(51) Int. Cl. G02B 26/10; F21V 8/00; G02B 6/32

(52) U.S. Cl. CPC G02B 26/10; G02B 2006/0098; G02B 6/32; G02B 6/0006

(57) ABSTRACT

An optical fiber scanner of the present invention includes: an optical fiber; a vibration device that vibrates the optical fiber; and a fixturethat fixes the optical fiber. The vibration device includes: a piezoelectric element; and an elastic member thattransmits the vibration of the piezoelectric element to the optical fiber. The piezoelectric element includes: first and second piezoelectrically active region; and a piezoelectrically inactive region arranged so as to fill a space between the adjacent end surfaces of these active regions. The second moments of area of a transverse shape formed of the piezoelectric element, the optical fiber, and the elastic member in two axial directions that are orthogonal to the longitudinal axis of the optical fiber and that are orthogonal to each other are same at the position of the vibration device.

### CROSS-REFERENCE TO RELATED APPLICATIONS

This is a continuation of International Application PCT/JP2016/081176, with an international filing date of Oct. 20, 2016, which is hereby incorporated by reference herein in its entirety. This application claims the benefit of International Application PCT/JP2016/081176, the content of which is incorporated herein by reference.

### TECHNICAL FIELD

The present invention relates to an optical fiber scanner, an illumination device, and an observation device.

### BACKGROUND ART

There is a known optical fiber scanner that is provided with a total of two piezoelectric elements including a piezoelectric element vibrating in the X-axis direction and a piezoelectric element vibrating in the Y-axis direction and that has an optical fiber disposed on the piezoelectric element vibrating in the X-axis direction (refer to, for example, U.S. Pat. No. 8,553,337). In this optical fiber scanner, the piezoelectric element driven with a resonant frequency vibrates in the X-axis direction, and the piezoelectric element driven with a non-resonant frequency vibrates in the Y-axis direction, thereby causing the optical fiber to undergo bending vibrations to two-dimensionally scan light emitted from the distal end of the optical fiber.

### CITATION LIST

### SUMMARY OF INVENTION

A first aspect of the present invention is an optical fiber scanner including: an optical fiber that has a longitudinal axis and that emits light from a distal end portion; a vibration device that is configured to vibrate the distal end portion of the optical fiber in a direction intersecting the longitudinal axis; and a fixture that is configured to fix a proximal end side of the optical fiber; wherein the vibration device includes a piezoelectric element that is configured to generate vibration due to voltage application and an elastic member that holds the optical fiber at a position more proximal than the distal end portion and that transmits vibration of the piezoelectric element to the optical fiber; the piezoelectric element includes a first piezoelectrically active region and a second piezoelectrically active region formed of band-plate shape that are arranged along the longitudinal axis of the optical fiber so as to be orthogonal to each other and each of which is sandwiched between two electrodes in a board-thickness direction and a piezoelectrically inactive region that is disposed so as to fill a space between widthwise adjacent end surfaces of the first piezoelectrically active region and the second piezoelectrically active region and that connects the first piezoelectrically active region and the second piezoelectrically active region; and the second moments of area of a transverse shape formed of the piezoelectric element, the optical fiber, and the elastic member in two axial directions that are orthogonal to the longitudinal axis of the optical fiber and that are orthogonal to each other are same at a position of the vibration device.

In the above-described first aspect, the transverse shape is preferably square shape.

In the above-described first aspect, the piezoelectric element may be formed so as to have a L-shaped transverse cross-section by arranging the one first piezoelectrically active region and the one second piezoelectrically active region orthogonally to each other with the one piezoelectrically inactive region interposed therebetween, and the elastic member may have a through-hole through which the optical fiber is made to pass in the longitudinal direction and may be formed in the shape of a cylinder formed so as to have a square transverse cross-section.

In the above-described first aspect, the piezoelectric element may be formed so as to have a L-shaped transverse cross-section by arranging the one first piezoelectrically active region and the one second piezoelectrically active region orthogonally to each other with the one piezoelectrically inactive region interposed therebetween, and the elastic member may be formed so as to have a L-shaped transverse cross-section such that the optical fiber is sandwiched between the elastic member and the piezoelectric element.

In the above-described first aspect, the piezoelectric element may be formed so as to have a U-shaped transverse cross-section by arranging the one first piezoelectrically active region and two of the second piezoelectrically active regions orthogonally to each other with two of the piezoelectrically inactive regions interposed therebetween, and the elastic member may have a through-hole through which the optical fiber is made to pass in the longitudinal direction and may be formed in the shape of a cylinder formed so as to have a square transverse cross-section.

In the above-described first aspect, the piezoelectric element may be formed so as to have a U-shaped transverse cross-section by arranging the one first piezoelectrically active region and two of the second piezoelectrically active regions orthogonally to each other with two of the piezoelectrically inactive regions interposed therebetween, and the elastic member may be formed so as to have a rectangular transverse cross-section such that the optical fiber is sandwiched between the elastic member and the piezoelectric element.

In the above-described first aspect, a thickness dimension of the first piezoelectrically active region may be larger than a thickness dimension of each of the second piezoelectrically active regions.

A second aspect of the present invention is an illumination device including: a light source; one of the above-described optical fiber scanners that is configured to scan light from the light source; and a focusing lens that is configured to focus the light scanned by the optical fiber scanner.

A third aspect of the present invention is an observation device including: the above-described illumination device; and a light detection unit that is configured to detect return light from a subject when the illumination device irradiates the subject with light.

### BRIEF DESCRIPTION OF DRAWINGS

FIG. 1 is an overall configuration diagram of an observation device according to a first embodiment of the present invention.

FIG. 2 is a longitudinal sectional view, taken along a longitudinal axis, showing the internal configuration of a distal end of an insertion section of an endoscope in FIG. 1.

FIG. 3 is a perspective view showing an optical fiber scanner provided in the observation device in FIG. 2.

FIG. 4A is a longitudinal sectional view showing an optical fiber scanner, according to the first embodiment of the present invention, provided in the observation device in FIG. 2.

FIG. 4B is a cross-sectional view, taken along line A-A, of a vibration device of the optical fiber scanner in FIG. 4A.

FIG. 4C is a cross-sectional view showing a state where the optical fiber scanner in FIG. 4A is used.

FIG. 5A is a cross-sectional view showing a vibration device of an optical fiber according to a second embodiment of the vibration device of the present invention.

FIG. 5B is a cross-sectional view showing a modification of the vibration device in FIG. 5A.

FIG. 6A is cross-sectional view showing a vibration device of an optical fiber according to a third embodiment of the vibration device of the present invention.

FIG. 6B is a cross-sectional view showing a first modification of the vibration device in FIG. 6A.

FIG. 6C is a cross-sectional view showing a second modification of the vibration device in FIG. 6A.

FIG. 6D is a cross-sectional view showing a third modification of the vibration device in FIG. 6A.

FIG. 7 is a cross-sectional view showing a vibration device of an optical fiber scanner according to prior art.

FIG. 8A is a diagram depicting an assembly state of the vibration device in FIG. 4B.

FIG. 8B is a diagram depicting an assembly state of the vibration device in FIG. 5A.

### DESCRIPTION OF EMBODIMENTS

### First Embodiment

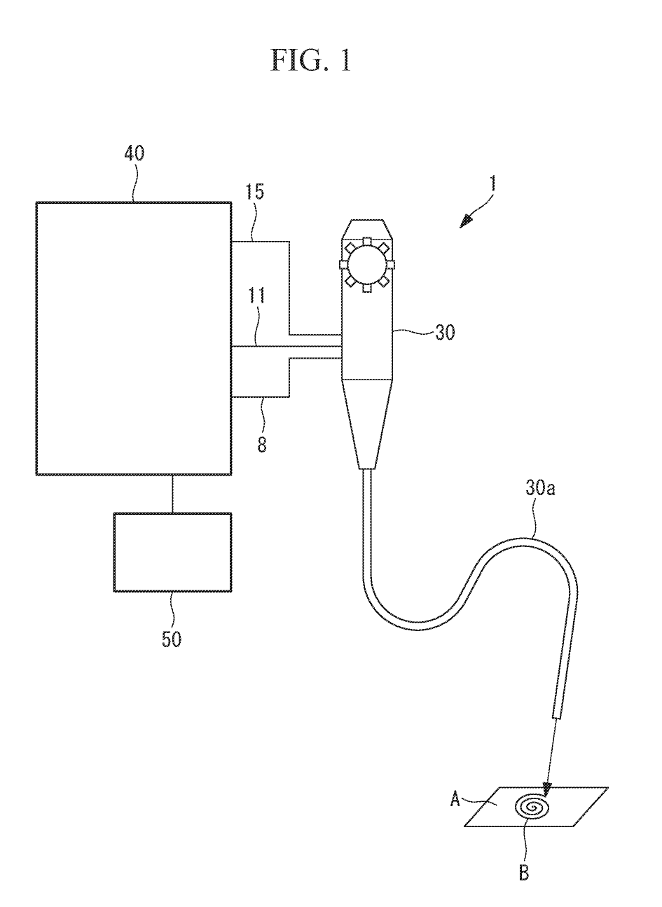

An optical fiber scanner 10, an illumination device 2, and an observation device 1 according to a first embodiment of the present invention will now be described with reference to FIGS. 1 to 4C.

As shown in FIG. 1, the observation device 1 according to this embodiment includes: an endoscope 30 having an elongated insertion section 30a; a control device main body 40 connected to the endoscope 30; and a display 50 connected to the control device main body 40. The observation device 1 is an optical scanning endoscope device that scans, along a spiral scanning trajectory B on a subject A, illumination light emitted from the distal end of the insertion section 30a of the endoscope 30 to acquire an image of the subject A.

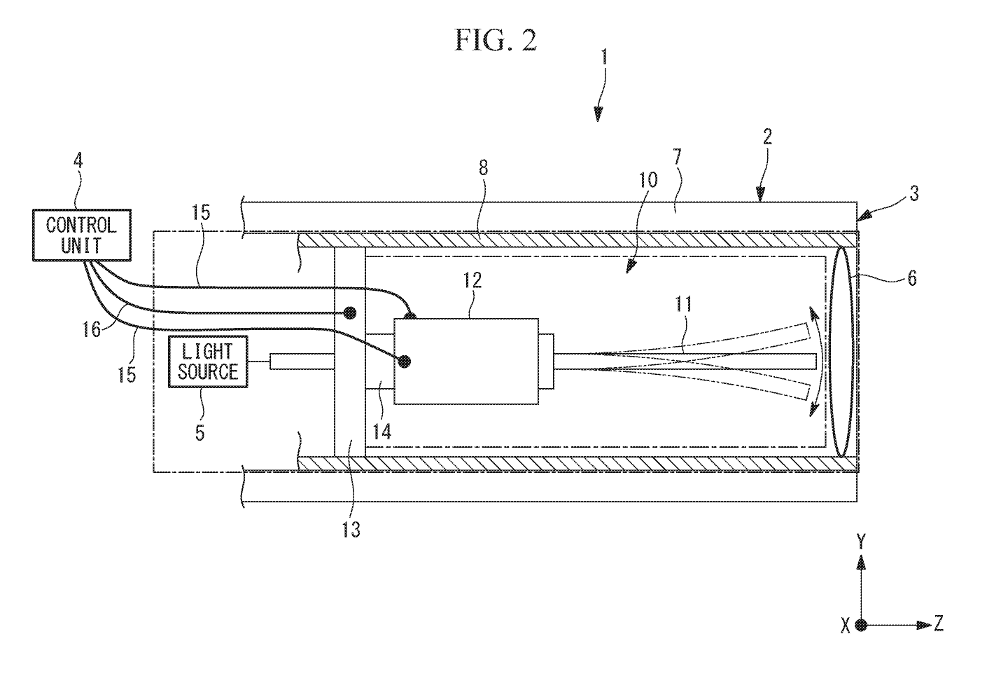

As shown in FIGS. 1 and 2, the observation device 1 according to this embodiment includes: the illumination device 2 for irradiating the subject A with illumination light; a light detection unit 3, such as a photodiode, for detecting return light that returns from the subject A irradiated with the illumination light; and a control unit 4 for driving and controlling the illumination device 2 and the light detection unit 3. The light detection unit 3 and the control unit 4 are provided in the control device main body 40.

The illumination device 2 includes: a light source 5 for generating light such as illumination light; the optical fiber scanner 10 for scanning the light from the light source 5; a focusing lens 6 that is disposed at a position more distal than the optical fiber scanner 10 and that focuses the illumination light emitted from the optical fiber scanner 10; an elongated tubular frame body 7 for accommodating the optical fiber scanner 10 and the focusing lens 6; and a detecting optical fiber 8 that is provided on the outer circumferential surface of the frame body 7 so as to be arranged along the circumferential direction and that guides return light (e.g., reflected illumination light and fluorescence) from the subject A to the light detection unit 3.

As shown in FIGS. 1 to 4A, the optical fiber scanner 10 includes: a lighting optical fiber (optical fiber) 11, such as a multimode fiber or a single-mode fiber, that guides light from the light source 5 and that emits the light from the distal end; an elastic member 14 that is fixed on the outer circumferential surface of the lighting optical fiber 11 to hold this optical fiber 11; a piezoelectric element 12 fixed to an outer surface of the elastic member 14; and a fixing part (fixture) 13 that is provided on the proximal end side of the elastic member 14 and that fixes the lighting optical fiber 11 to the frame body 7. Lead wires 15 for supplying an AC voltage are connected to the piezoelectric element 12. The light source 5 is connected to the proximal end of the lighting optical fiber 11.

The lighting optical fiber 11 is a multimode fiber or a single-mode fiber formed of an elongated glass material having a circular transverse cross-section and is arranged along the longitudinal direction of the frame body 7. The distal end of the lighting optical fiber 11 is disposed near the distal end portion inside the frame body 7, and the proximal end of the lighting optical fiber 11 extends to the outside through the proximal end of the frame body 7 and is connected to the light source 5.

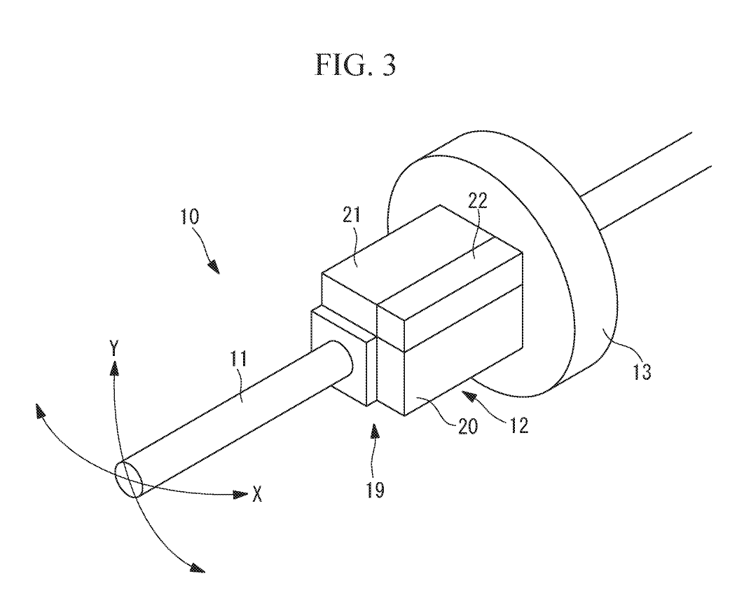

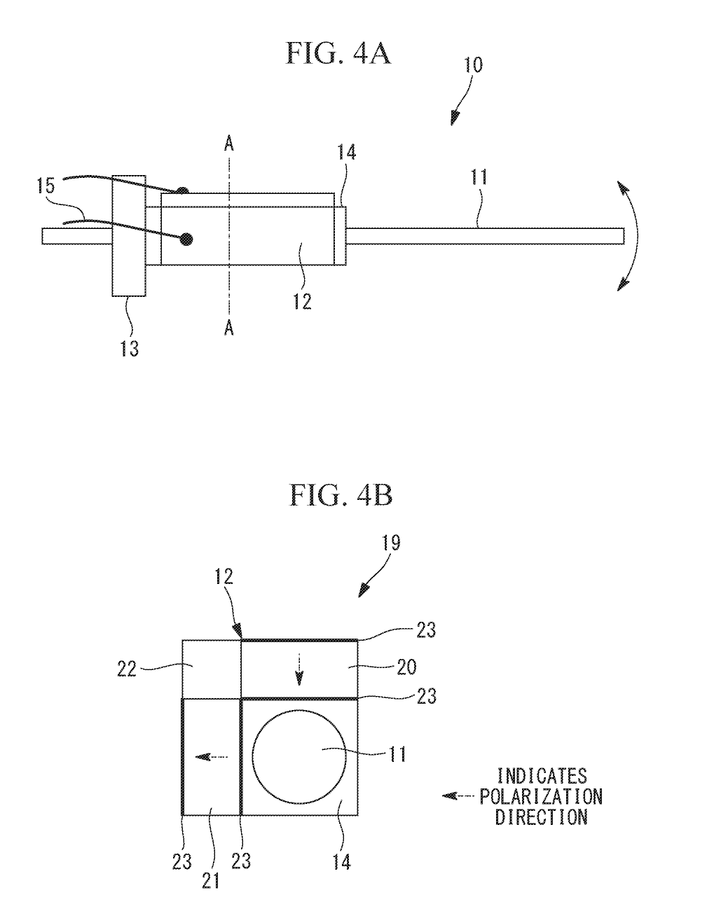

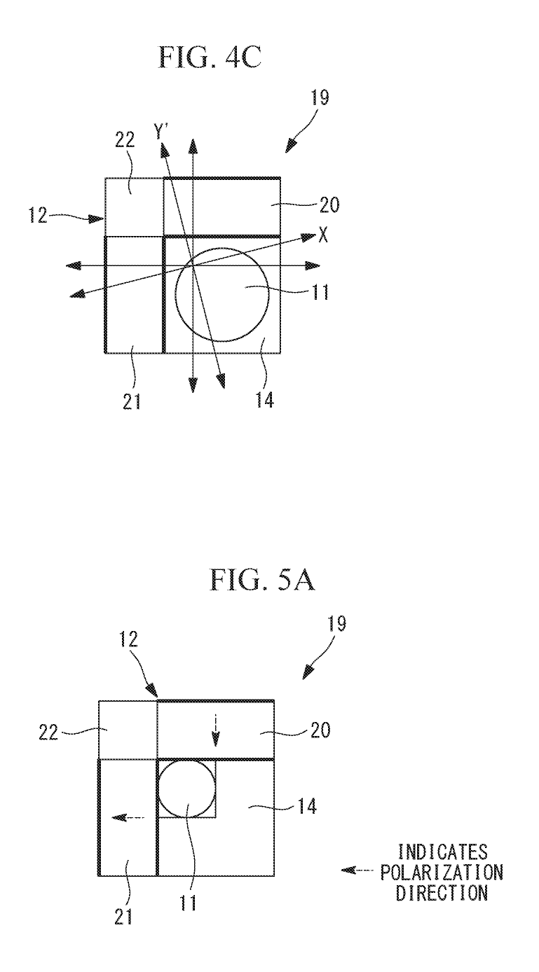

The piezoelectric element 12 is formed of a piezoelectric ceramic material that is uniform over the entirety thereof, such as lead zirconate titanate (PZT), and has a seamless, integrated structure. As shown in FIGS. 3 to 4C, the piezoelectric element 12 is formed so as to have a substantially L-shaped transverse cross-section taken along an XY plane orthogonal to the longitudinal direction thereof. Such a piezoelectric element 12 is produced by cutting out from, for example, a rectangular columnar piezoelectric material.

Hereinafter, the longitudinal direction of the lighting optical fiber 11 is defined as a Z-axis direction, and two radial directions of the lighting optical fiber 11 orthogonal to each other are defined as an X-axis direction and a Y-axis direction.

As shown in FIGS. 3 and 4B, the piezoelectric element 12 includes: a first piezoelectrically active region 20 that extends along the longitudinal axis of the lighting optical fiber 11 and that is adjacent to the lighting optical fiber 11 in the X-axis direction; a second piezoelectrically active region 21 that extends along the longitudinal axis of the lighting optical fiber 11 and that is adjacent to the lighting optical fiber 11 in the Y-axis direction; and a piezoelectrically inactive region 22 that is disposed so as to fill the space between widthwise adjacent end surfaces of the first piezoelectrically active region 20 and the second piezoelectrically active region 21 and that connects both the piezoelectrically active regions.

Electrode processing for + (plus) is applied to the outer surfaces of the first piezoelectrically active region 20 and the second piezoelectrically active region 21 of the piezoelectric element 12, and electrode processing for − (minus) is applied to the inner surfaces thereof. As a result, polarization occurs from the + pole towards the − pole in the board-thickness direction, and stretching vibration (transversal effect) occurs in a direction orthogonal to the polarization direction when a voltage is applied.

Electrodes 23 are formed on the inner surface and the outer surface of the first piezoelectrically active region 20, and the piezoelectric material is polarized in the X-axis direction in the region between the inner surface and the outer surface. Electrodes 23 are also formed on the inner surface and the outer surface of the second piezoelectrically active region 21, and the piezoelectric material is polarized in the Y-axis direction in the region between the inner surface and the outer surface. The arrows in FIG. 4B indicate the polarization directions.

Voltages are applied to the piezoelectric element 12 via the lead wires 15 attached to the outer surfaces of the first piezoelectrically active region 20 and the second piezoelectrically active region 21. More specifically, an AC voltage of phase A is applied to the first piezoelectrically active region 20, and an AC voltage of phase B is applied to the second piezoelectrically active region 21, whereby bending vibration is transmitted to the lighting optical fiber 11 via the elastic member 14, and the exit end of the lighting optical fiber 11 is displaced and vibrated in the X-axis direction and the Y-axis direction intersecting the Z-axis direction.

The elastic member 14 is formed in a rectangular cylindrical shape, and, as shown in FIG. 4B, a transverse cross-section as viewed in the longitudinal direction (Z-axis direction) is formed in a substantially square shape. A through-hole through which the lighting optical fiber 11 passes is formed in the center of this elastic member 14. The elastic member 14 is formed of, for example, a metal material or a resin material having conductivity, such as zirconia (ceramic) or nickel.

A vibrating part (vibration device) 19 is formed by bonding the flat inner surface of the first piezoelectrically active region 20 and the flat inner surface of the second piezoelectrically active region 21 of the piezoelectric element 12 to two respective flat outer surfaces of the elastic member 14 by means of an adhesive. As shown in FIG. 4B, at the position of the vibrating part 19, a transverse cross-section composed of the piezoelectric element 12, the optical fiber 11, and the elastic member 14, as viewed in the longitudinal direction (Z-axis direction), is formed in a substantially square shape.

The fixing part 13 is a substantially ring-shaped conductive member having a center hole and, as shown in FIG. 3, is fixed by means of an adhesive in a state where the elastic member 14 located at a position more proximal than the piezoelectric element 12, is fitted into the center hole. As shown in FIG. 2, the outer circumferential surface of the fixing part 13 is fixed to the inner wall of the frame body 7, the elastic member 14 is supported by the fixing part 13 in a cantilever form, and the distal end portion of the lighting optical fiber 11 is supported by the elastic member 14 in the form of a cantilever where the distal end is a free end. A GND wire 16 is connected to the proximal end side of the elastic member 14.

The fixing part 13 is electrically connected to the inner surfaces of the first piezoelectrically active region 20 and the second piezoelectrically active region 21 of the piezoelectric element 12 via the elastic member 14 and functions as a common GND when the first piezoelectrically active region 20 and the second piezoelectrically active region 21 of the piezoelectric element 12 are driven.

The lead wires 15 and the GND wire 16 are formed of a wire having conductivity (e.g., copper, aluminum, etc.). As shown in FIG. 2, the proximal end sides of the lead wires 15 and the GND wire 16 are connected to the control unit 4.

The operation of the optical fiber scanner 10, the illumination device 2, and the observation device 1 according to this embodiment with the above-described structure will be described below.

In order to observe the subject A by using the observation device 1 according to this embodiment, the control unit 4 is operated, illumination light is supplied from a light source 5 to the lighting optical fiber 11, and AC voltages having a predetermined driving frequency are applied to the piezoelectric element 12 via the lead wires 15.

The first piezoelectrically active region 20 to which an AC voltage of phase A is applied undergoes stretching vibration in the Z-axis direction orthogonal to the polarization direction, whereby the bending vibration in the X-axis direction is transmitted to the distal end of the lighting optical fiber 11 via the elastic member 14. By doing so, as shown in FIG. 3, the distal end of the lighting optical fiber 11 vibrates in the X-axis direction by undergoing bending vibration in the X-axis direction with a frequency equal to the driving frequency of the AC voltage, and illumination light emitted from the distal end is linearly scanned in the X-axis direction.

In the same manner, the second piezoelectrically active region 21 to which an AC voltage of phase B is applied undergoes stretching vibration in the Z-axis direction orthogonal to the polarization direction, whereby bending vibration in the Y-axis direction is transmitted to the distal end of the lighting optical fiber 11 via the elastic member 14. By doing so, as shown in FIG. 3, the distal end of the lighting optical fiber 11 vibrates in the Y-axis direction by undergoing bending vibration in the Y-axis direction with a frequency equal to the driving frequency of the AC voltage, and illumination light emitted from the distal end is linearly scanned in the Y-axis direction.

Return light from the subject A is received by the detecting optical fiber 8, and the intensity thereof is detected by the light detection unit 3. The control unit 4 makes the light detection unit 3 detect the return light in synchronization with the scanning cycle of the illumination light and generates an image of the subject A by associating the intensity of the detected return with the scanning position of the illumination light. The generated image is output from the control device main body 40 to the display 50 and is displayed.

Here, regarding the natural frequency in a typical structured body, the natural frequency (resonance point) can be represented by calculation Expression (1) below.

fn=(kn²/2π)√(EI/ρAL⁴) (1)

fn: natural frequency

kn: constant corresponding to eigenvalue

E: longitudinal elastic modulus

I: second moment of area

A: cross-sectional area

L: length

ρ: density

Therefore, in a typical structured body, the natural frequency can be changed by changing each parameter included in Expression (1).

As shown in FIG. 4B, in the optical fiber scanner 10 according to this embodiment, the piezoelectric element 12 is formed so as to have a substantially L-shaped transverse cross-section as a result of one first piezoelectrically active region 20 and one second piezoelectrically active region 21 being arranged orthogonally to each other with one piezoelectrically inactive region 22 interposed therebetween. More particularly, by bonding outer surfaces of the elastic member 14 formed so as to have a substantially square transverse cross-section to the inner surface of the first active region 20 and to the inner surface of the second active region 21 of the piezoelectric element 12, a uniform structure whose transverse cross-section taken at the position of the vibrating part 19 is substantially square is formed. Because the optical fiber scanner 10 is formed as described above, even if vibration directions are inclined due to non-uniformity of specific gravity etc., the same second moment of area is achieved in the inclined directions with respect to the center on the cross section, as shown in FIG. 4C. As a result, the natural frequencies exhibit substantially the same value, and the difference in resonant frequency of the optical fiber between the X-axis direction and the Y-axis direction becomes small, stabilizing the vibrations in the X-axis direction and Y-axis direction.

The transverse cross-section taken at the position of the vibrating part 19 is formed in a substantially square shape by combining the piezoelectric element 12, formed so as to have a substantially L-shaped transverse cross-section and the elastic member 14, formed so as to have a substantially square transverse cross-section. Therefore, a transverse shape of the lighting optical fiber 11 in which the second moments of area in the X-axis direction and the Y-axis direction that are orthogonal to the longitudinal direction (Z-axis direction) become substantially the same can be easily processed.

Furthermore, by abutting outer surfaces of the elastic member 14 against the two mutually orthogonal inner surfaces of the piezoelectric element 12, the elastic member 14 is positioned at a predetermined position relative to the piezoelectric element 12, thus eliminating the need for alignment in directions other than in the longitudinal direction. This affords an advantage in that the assembly precision of the optical fiber scanner 10 can be enhanced and that an optical fiber scanner 10 having desired scanning performance can be manufactured stably. Furthermore, because it is sufficient merely that lead wire 15 for supplying electrical power to the piezoelectric element 12 is attached to a total of two sites including the first piezoelectrically active region 20 and the second piezoelectrically active region 21, the work of routing wiring is reduced, simplifying assembling of the optical fiber scanner 10.

### Second Embodiment

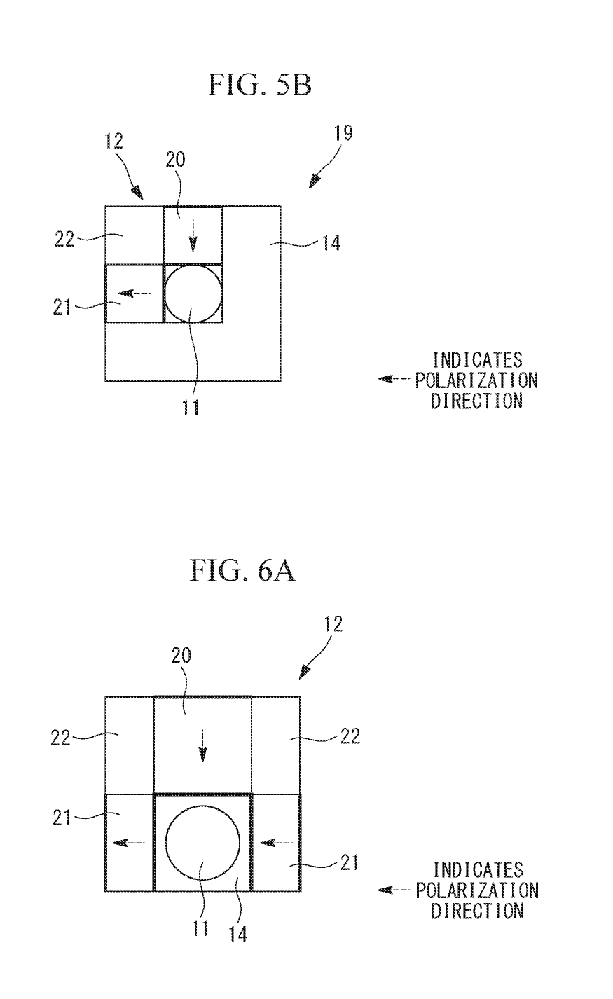

Next, an optical fiber scanner 10, an illumination device 2, and an observation device 1 according to a second embodiment of the present invention will be described with reference to FIGS. 5A and 5B. In this embodiment, configurations different from those in the first embodiment will be mainly described. Configurations in common with those in the first embodiment will be denoted by the same reference signs, and a description thereof will be omitted.

As shown in FIG. 5A, the optical fiber scanner 10 according to this embodiment differs from that in the first embodiment in that the elastic member 14 is formed in the shape of a polygonal column whose transverse cross-section as viewed in the longitudinal direction (Z-axis direction) has a substantially L shape. The elastic member 14 has a seamless, integrated structure. Such an elastic member 14 can be produced by cutting out from, for example, a rectangular columnar material.

In this embodiment, the elastic member 14 has a transverse cross-section that is smaller than that of the piezoelectric element 12 and that has a shape similar to that of the piezoelectric element 12, i.e., a substantially L shape. As shown in FIG. 5A, by bonding the two end surfaces of the elastic member 14 to the two inner surfaces of the piezoelectric element 12 (the inner surface of the first active region 20 and the inner surface of the second active region 21), a uniform structure whose transverse cross-section taken at the position of the vibrating part 19 is substantially square is formed.

By doing so, a transverse shape in which the second moments of area in the X-axis direction and the Y-axis direction become substantially the same can be easily processed. Because alignment in directions other than in the longitudinal direction is not needed, the optical fiber scanner 10 can be assembled more easily.

The piezoelectric element 12 has two inner surfaces including the inner surface of the first piezoelectrically active region 20 and the inner surface of the second piezoelectrically active region 21, and the elastic member 14 has two inner surfaces that form a substantially L-shaped inner surface. The two inner surfaces of the piezoelectric element 12 and the two inner surfaces of the elastic member 14 have the same height dimension, which is substantially the same as the radius of the lighting optical fiber 11.

The lighting optical fiber 11 is disposed in the space surrounded by the inner surface of the first piezoelectrically active region 20, the inner surface of the second piezoelectrically active region 21, and the two inner surfaces of the elastic member 14, and the outer circumferential surface of the lighting optical fiber 11 is supported by these four inner surfaces at four points shifted by 90° from one another in the circumferential direction. Therefore, it is possible to more stably hold the lighting optical fiber 11. The elastic member 14 does not need to have a through-hole through which the lighting optical fiber 11 is inserted, making it easy to process the lighting optical fiber 11. Furthermore, because it is sufficient that the lighting optical fiber 11 is inserted into the space surrounded by the two inner surfaces of a piezoelectric element 12 and the two inner surfaces of the elastic member 14, the optical fiber scanner 10 can be assembled more easily.

Although the elastic member 14 is smaller than the piezoelectric element 12 and has a shape similar to that of the piezoelectric element 12 in this embodiment, instead of this, the elastic member 14 may be larger than the piezoelectric element 12 and may have a shape similar to that of the piezoelectric element 12, as shown in FIG. 5B. In this case, as shown in FIG. 5B, by bonding the two end surfaces of the piezoelectric element 12 to the two inner surfaces of the elastic member 14, a uniform structure whose transverse cross-section taken at the position of the vibrating part 19 is substantially square is formed.

By doing so, a transverse shape in which the second moments of area in the X-axis direction and the Y-axis direction become substantially the same can be easily processed. Note that if a resin material is used as the material of the elastic member 14, the Q value of the entire vibrating part 19 decreases, making it possible to further stabilize vibration.

### Third Embodiment

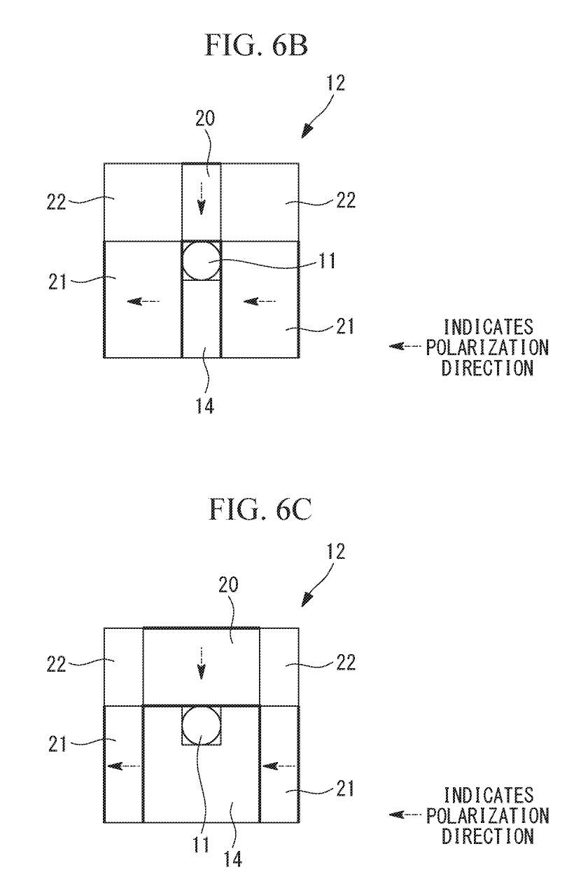

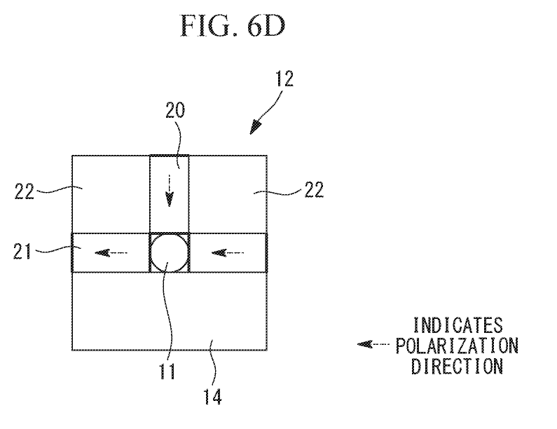

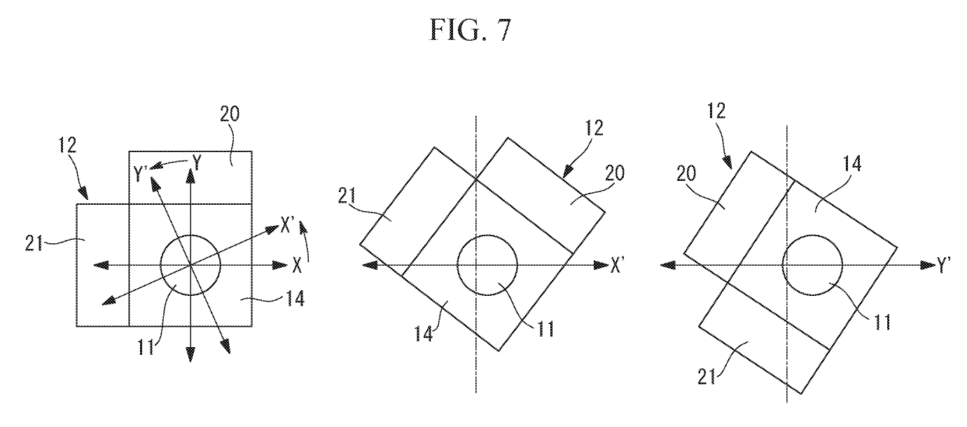

Next, an optical fiber scanner 10, an illumination device 2, and an observation device 1 according to a third embodiment of the present invention will be described with reference to FIGS. 6A to 6D. In this embodiment, configurations different from those in the first and second embodiments will be mainly described. Configurations in common with those in the first and second embodiments will be denoted by the same reference signs, and a description thereof will be omitted.

As shown in FIGS. 6A to 6D, the optical fiber scanner 10 according to this embodiment differs from those in the first and second embodiments in that the piezoelectric element 12 is formed so as to have a substantially U-shaped transverse cross-section taken along an XY plane orthogonal to the longitudinal direction.

In this embodiment, the piezoelectrically inactive regions 22 are provided between: both end sections of the one first piezoelectrically active region 20; and end sections of the two second piezoelectrically active regions 21, said end sections being located on the first piezoelectrically active region 20 side. Therefore, in the piezoelectric element 12, the side opposite from the first piezoelectrically active region 20 is open.

In this embodiment, the elastic member 14 is formed so as to have a substantially square transverse cross-section as viewed in the longitudinal direction (Z-axis direction). Also, at the center of the elastic member 14, a through-hole through which the lighting optical fiber 11 passes is formed. As shown in FIG. 6A, by bonding the three outer surfaces of the elastic member 14 to the three inner surfaces of the piezoelectric element 12 (the inner surface of the one first active region 20 and the inner surfaces of the two second active regions 21), a uniform structure whose transverse cross-section taken at the position of the vibrating part 19 is substantially square is formed.

By doing so, a transverse shape in which the second moments of area in the X-axis direction and the Y-axis direction become substantially the same can be easily processed. Because alignment in directions other than in the longitudinal direction is not needed, the optical fiber scanner 10 can be assembled more easily.

The piezoelectric element 12 has three inner surfaces, which are the inner surface of the one first piezoelectrically active region 20 and the inner surfaces of the two second piezoelectrically active regions 21, and as shown in FIG. 6A, the three outer surfaces of the elastic member 14 are in contact with these three inner surfaces. The lighting optical fiber 11 is inserted into a through-hole provided at the center of the elastic member 14 in the Z-axis direction.

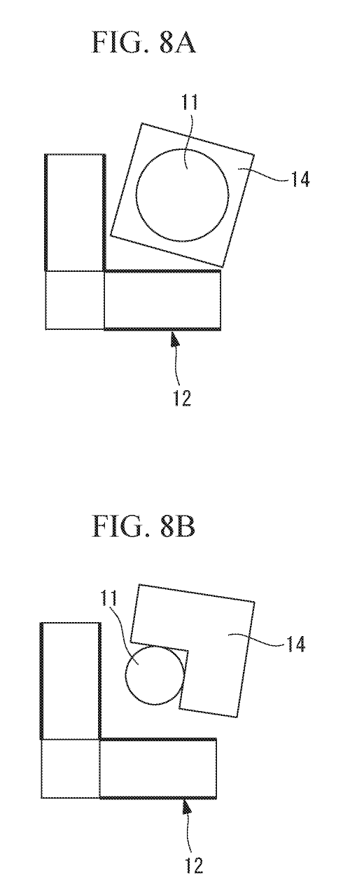

In this embodiment, the elastic member 14 can be arranged more easily relative to the piezoelectric element 12, compared with the first embodiment and the second embodiment. More specifically, as shown in FIGS. 8A and 8B, if the vibrating part 19 is formed by combining the elastic member 14 having a substantially square transverse cross-section or a substantially L-shaped transverse cross-section with the piezoelectric element 12 having a substantially L-shaped transverse cross-section, the position of the elastic member 14 is shifted in the X-axis direction or the Y-axis direction, decreasing the assembly precision in some cases. In this embodiment, however, because the elastic member 14 can be disposed in the space of the piezoelectric element 12 formed so as to have a substantially U-shaped transverse cross-section, position shift in the X-axis direction can be prevented, making it possible to enhance the assembly precision.

Note that although the elastic member 14 is formed so as to have a substantially square transverse cross-section and the lighting optical fiber 11 is made to pass though at the center of the elastic member 14 in this embodiment, instead of this, the elastic member 14 may be formed so as to have a substantially rectangular transverse cross-section (refer to FIGS. 6B and 6D) or a substantially U-shaped transverse cross-section (refer to FIG. 6C), thereby arranging the lighting optical fiber 11 in the space surrounded by the inner surface(s) of the piezoelectric element 12 and the outer surface(s) of the elastic member 14.

By doing so, the outer circumferential surface of the lighting optical fiber 11 is supported at four points shifted by 90° relative to one another in the circumferential direction, making it possible to more stably hold the lighting optical fiber 11. The elastic member 14 does not need to have a through-hole through which the lighting optical fiber 11 is inserted, making it easy to process the lighting optical fiber 11. Furthermore, because it is sufficient that the lighting optical fiber 11 is inserted into the space surrounded by the inner surface(s) of the piezoelectric element 12 and the outer surface(s) of the elastic member 14, the optical fiber scanner 10 can be assembled more easily.

As shown in FIGS. 6A and 6C, the thickness dimension of the first piezoelectrically active region 20 of the piezoelectric element 12 may be set to be larger than the thickness dimensions of the second piezoelectrically active regions 21. Note that, in the examples disclosed in FIGS. 6A and 6C, the first piezoelectrically active region 20 is formed so as to have a thickness dimension about twice that of the second piezoelectrically active regions 21.

By doing so, the resonant frequency of bending vibration of the lighting optical fiber 11 in the X-axis direction can be made closer to the resonant frequency of bending vibration of the lighting optical fiber 11 in the Y-axis direction, making it possible to further stabilize the bending vibration of the lighting optical fiber 11.

If the first piezoelectrically active region 20 is formed so as to have a thickness dimension about twice that of the second piezoelectrically active regions 21, the amplitude of bending vibration of the distal end of the lighting optical fiber 11 in the X-axis direction becomes identical to that in the Y-axis direction as long as the amplitudes of AC voltages of phase A and phase B are equal. More specifically, it is sufficient that AC voltages having the same amplitude are supplied to the first piezoelectrically active region 20 and the second piezoelectrically active regions 21, making it easier to control AC voltages.

As a result, the following aspects are derived from the above-described embodiments.

A first aspect of the present invention is an optical fiber scanner including: an optical fiber that has a longitudinal axis and that emits light from a distal end portion; a vibration device that is configured to vibrate the distal end portion of the optical fiber in a direction intersecting the longitudinal axis; and a fixture that is configured to fix a proximal end side of the optical fiber; wherein the vibration device includes a piezoelectric element that is configured to generate vibration due to voltage application and an elastic member that holds the optical fiber at a position more proximal than the distal end portion and that transmits vibration of the piezoelectric element to the optical fiber; the piezoelectric element includes a first piezoelectrically active region and a second piezoelectrically active region formed of band-plate shape that are arranged along the longitudinal axis of the optical fiber so as to be orthogonal to each other and each of which is sandwiched between two electrodes in a board-thickness direction and a piezoelectrically inactive region that is disposed so as to fill a space between widthwise adjacent end surfaces of the first piezoelectrically active region and the second piezoelectrically active region and that connects the first piezoelectrically active region and the second piezoelectrically active region; and the second moments of area of a transverse shape formed of the piezoelectric element, the optical fiber, and the elastic member in two axial directions that are orthogonal to the longitudinal axis of the optical fiber and that are orthogonal to each other are same at a position of the vibration device.

According to the first aspect of the present invention, when a voltage is applied to the first piezoelectrically active region, the first piezoelectrically active region deforms in the longitudinal direction of the optical fiber, whereby the optical fiber bends and deforms in a first radial direction, thereby causing the distal end of the optical fiber to be displaced in the first radial direction. Because of this, light emitted from the distal end of the optical fiber is scanned in the first radial direction. Similarly, when a voltage is applied to the second piezoelectrically active region, the second piezoelectrically active region deforms in the longitudinal direction of the optical fiber, whereby the optical fiber bends and deforms in a second radial direction, thereby causing the distal end of the optical fiber to be displaced in the second radial direction. Because of this, light emitted from the distal end of the optical fiber is scanned in the second radial direction, which intersects the first radial direction. Therefore, when voltages are applied simultaneously to the first piezoelectrically active region and the second piezoelectrically active region, light can be scanned two-dimensionally.

In this case, the second moments of area of the transverse shape formed of the piezoelectric element, the optical fiber, and the elastic member in the two axial directions that are orthogonal to the longitudinal axis of the optical fiber and that are orthogonal to each other are same at the position of the vibration device. Therefore, even if the specific gravity etc. of the optical fiber scanner becomes non-uniform and thereby vibration directions are inclined, the resonant frequencies can be made same between the X-axis direction and the Y-axis direction. By doing so, when the piezoelectric element vibrating in the X-axis direction and the piezoelectric element vibrating in the Y-axis direction are to be operated with the same resonant frequency, the difference in resonant frequency between the X-axis direction and the Y-axis direction can be decreased, thereby making it possible to stabilize vibration of the distal end portion of the optical fiber by preventing unwanted vibration.

In the above-described first aspect, the transverse shape is preferably square shape.

By doing so, a transverse shape in which the second moments of area in the two axial directions that are orthogonal to the longitudinal axis of the optical fiber and that are orthogonal to each other become same can be easily processed.

In the above-described first aspect, the piezoelectric element may be formed so as to have a L-shaped transverse cross-section by arranging the one first piezoelectrically active region and the one second piezoelectrically active region orthogonally to each other with the one piezoelectrically inactive region interposed therebetween, and the elastic member may have a through-hole through which the optical fiber is made to pass in the longitudinal direction and may be formed in the shape of a cylinder formed so as to have a square transverse cross-section.

By doing so, merely by bonding outer surfaces of the cylindrical elastic member formed so as to have a square transverse cross-section to the inner surfaces of the one piezoelectric element formed so as to have a L-shaped transverse cross-section (the inner surface of the first active region and the inner surface of the second active region), the transverse shape, at the position of the vibration device, formed of the piezoelectric element, the optical fiber, and the elastic member can be easily formed into a square shape. Because alignment in directions other than in the longitudinal direction is not needed, the optical fiber scanner can be assembled more easily. Furthermore, because it is sufficient merely that wiring for supplying electrical power to the piezoelectric element is attached to a total of two sites including the first piezoelectrically active region and the one second piezoelectrically active region, the work of routing wiring is reduced, simplifying assembling of the optical fiber scanner.

Because the optical fiber scanner is formed in a state where the optical fiber is pre-incorporated in the elastic member in the assembly process of the optical fiber scanner, it is possible to stably hold the optical fiber.

In the above-described first aspect, the piezoelectric element may be formed so as to have a L-shaped transverse cross-section by arranging the one first piezoelectrically active region and the one second piezoelectrically active region orthogonally to each other with the one piezoelectrically inactive region interposed therebetween, and the elastic member may be formed so as to have a L-shaped transverse cross-section such that the optical fiber is sandwiched between the elastic member and the piezoelectric element.

By doing so, merely by combining the piezoelectric element and the elastic member with the top and the bottom reversed such that end sections of the piezoelectric element formed so as to have a L-shaped transverse cross-section come into contact with end sections of the elastic member formed so as to have a L-shaped transverse cross-section, the transverse shape, at the position of the vibration device, formed of the piezoelectric element, the optical fiber, and the elastic member can be easily formed into a square shape. In this manner, because alignment in directions other than in the longitudinal direction is not needed, the optical fiber scanner can be assembled more easily.

In the assembly process of the optical fiber scanner, the optical fiber can be inserted along the longitudinal direction into the space surrounded by the inner surfaces of the piezoelectric element formed so as to have a L-shaped transverse cross-section and the inner surfaces of the elastic member formed so as to have a L-shaped transverse cross-section. Furthermore, by supporting the outer circumferential surface of the optical fiber at four points by means of the inner surfaces of the piezoelectric element and the inner surfaces of the elastic member, the optical fiber can be held more stably. Furthermore, because the work of inserting the optical fiber into the through-hole formed in the elastic member is not needed, it is possible to simplify assembling of the optical fiber scanner.

In the above-described first aspect, the piezoelectric element may be formed so as to have a U-shaped transverse cross-section by arranging the one first piezoelectrically active region and two of the second piezoelectrically active regions orthogonally to each other with two of the piezoelectrically inactive regions interposed therebetween, and the elastic member may have a through-hole through which the optical fiber is made to pass in the longitudinal direction and may be formed in the shape of a cylinder formed so as to have a square transverse cross-section.

By doing so, because the elastic member in which the optical fiber is incorporated is disposed in the space of the piezoelectric element formed so as to have a U-shaped transverse cross-section, position shift of the elastic member can be prevented, compared with the case where the elastic member is combined with the piezoelectric element formed so as to have a L-shaped transverse cross-section, thus making it possible to enhance the assembly precision.

In the above-described first aspect, the piezoelectric element may be formed so as to have a U-shaped transverse cross-section by arranging the one first piezoelectrically active region and two of the second piezoelectrically active regions orthogonally to each other with two of the piezoelectrically inactive regions interposed therebetween, and the elastic member may be formed so as to have a rectangular transverse cross-section such that the optical fiber is sandwiched between the elastic member and the piezoelectric element.

By doing so, because the optical fiber and the elastic member are disposed in the space of the piezoelectric element formed so as to have a U-shaped transverse cross-section, position shift of the optical fiber and the elastic member can be prevented, compared with the case where the elastic member is combined with the piezoelectric element formed so as to have a L-shaped transverse cross-section, thus making it possible to enhance the assembly precision.

In the above-described first aspect, a thickness dimension of the first piezoelectrically active region may be larger than a thickness dimension of each of the second piezoelectrically active regions.

By doing so, the resonant frequency of bending vibration of the optical fiber in the X-axis direction can be made closer to the resonant frequency of bending vibration of the optical fiber in the Y-axis direction, making it possible to further stabilize the bending vibration of the optical fiber.

A second aspect of the present invention is an illumination device including: a light source; one of the above-described optical fiber scanners that is configured to scan light from the light source; and a focusing lens that is configured to focus the light scanned by the optical fiber scanner.

A third aspect of the present invention is an observation device including: the above-described illumination device; and a light detection unit that is configured to detect return light from a subject when the illumination device irradiates the subject with light.

### REFERENCE SIGNS LIST

1 Observation device
2 Illumination device
3 Light detection unit
4 Control unit
5 Light source
10 Optical fiber scanner
11 Optical fiber (lighting optical fiber)
12 Piezoelectric element
13 fixture
14 Elastic member
15 Lead wire
19 vibration device
20 First active region
21 Second active region
22 Inactive region

1. An optical fiber scanner comprising:
an optical fiber that has a longitudinal axis and that emits light from a distal end portion;
a vibration device that is configured to vibrate the distal end portion of the optical fiber in a direction intersecting the longitudinal axis; and
a fixture that fixes a proximal end side of the optical fiber;
wherein the vibration device includes a piezoelectric element that is configured to generate vibration due to voltage application, and an elastic member that holds the optical fiber at a position more proximal than the distal end portion and that transmits vibration of the piezoelectric element to the optical fiber;
the piezoelectric element includes a first piezoelectrically active region and a second piezoelectrically active region formed of band-plate shape that are arranged along the longitudinal axis of the optical fiber so as to be orthogonal to each other and each of which is sandwiched between two electrodes in a board-thickness direction, and a piezoelectrically inactive region that is disposed so as to fill a space between widthwise adjacent end surfaces of the first piezoelectrically active region and the second piezoelectrically active region and that connects the first piezoelectrically active region and the second piezoelectrically active region; and
second moments of an area of a transverse shape formed of the piezoelectric element, the optical fiber, and the elastic member in two axial directions that are orthogonal to the longitudinal axis of the optical fiber and that are orthogonal to each other are same at a position of the vibration device.

2. The optical fiber scanner according to claim 1, wherein the transverse shape is square shape.

3. The optical fiber scanner according to claim 2,
wherein the piezoelectric element is formed so as to have a L-shaped transverse cross-section by arranging the one first piezoelectrically active region and the one second piezoelectrically active region orthogonally to each other with the one piezoelectrically inactive region interposed therebetween, and
the elastic member has a through-hole through which the optical fiber is made to pass in the longitudinal direction and is formed in the shape of a cylinder formed so as to have a square transverse cross-section.

4. The optical fiber scanner according to claim 2,
wherein the piezoelectric element is formed so as to have a L-shaped transverse cross-section by arranging the one first piezoelectrically active region and the one second piezoelectrically active region orthogonally to each other with the one piezoelectrically inactive region interposed therebetween, and
the elastic member is formed so as to have a L-shaped transverse cross-section such that the optical fiber is sandwiched between the elastic member and the piezoelectric element.

5. The optical fiber scanner according to claim 2,
wherein the piezoelectric element is formed so as to have a U-shaped transverse cross-section by arranging the one first piezoelectrically active region and two of the second piezoelectrically active regions orthogonally to each other with two of the piezoelectrically inactive regions interposed therebetween, and
the elastic member has a through-hole through which the optical fiber is made to pass in the longitudinal direction and is formed in the shape of a cylinder formed so as to have a square transverse cross-section.

6. The optical fiber scanner according to claim 2,
wherein the piezoelectric element is formed so as to have a U-shaped transverse cross-section by arranging the one first piezoelectrically active region and two of the second piezoelectrically active regions orthogonally to each other with two of the piezoelectrically inactive regions interposed therebetween, and
the elastic member is formed so as to have a rectangular transverse cross-section such that the optical fiber is sandwiched between the elastic member and the piezoelectric element.

7. The optical fiber scanner according to claim 5, wherein a thickness dimension of the first piezoelectrically active region is larger than a thickness dimension of each of the second piezoelectrically active regions.

8. An illumination device comprising:
a light source;
the optical fiber scanner according to claim 1 that is configured to scan light from the light source; and
a focusing lens that is configured to focus the light scanned by the optical fiber scanner.

9. An observation device comprising:
the illumination device according to claim 8; and
a light detection unit that is configured to detect return light from a subject when the illumination device irradiates the subject with light.
